(19) United States
(12) Patent Application Publication
(10) Pub. No.: US 2010/0246901 A1
(43) Pub. Date: Sep. 30, 2010

(54) Operation Support System, Vehicle, And Method For Estimating Three-Dimensional Object Area

(75) Inventor: Changhui Yang, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: Sanyo Electric Co., Ltd., Osaka (JP)

(21) Appl. No.: 12/743,383

(22) PCT Filed: Sep. 24, 2008
(86) PCT No.: PCT/JP2008/067150

§ 371 Date: May 18, 2010

(30) Foreign Application Priority Data
Nov. 20, 2007 (JP) 2007-300537

(51) Int. Cl. G06K 9/00

(52) U.S. Cl. 382/107; 382/154

(57) ABSTRACT

Camera images at times (t1 and t2) are acquired from a camera installed on a vehicle, and the camera images are converted to bird's-eye view images at the times (t1 and t2). A plurality of feature points are extracted from the camera image at the time (t1) and the movement vectors of the respective feature points between first and second camera images are detected. Then, the respective feature points and the respective movement vectors are mapped onto a bird's-eye image coordinate plane. Two or more feature points on the bird's-eye view images are permitted to be targets, the positions and the movement vectors of the target feature points are applied to an equation of constraint which ground surface feature points have to satisfy, thereby discriminating whether the target feature points are the ground surface feature points. Then, from position information and movement vector information on the two or more feature points discriminated to be the ground surface feature points, movement information on the vehicle is obtained and used for taking the difference between the bird's-eye images at the times (t1 and t2) to estimate a three-dimensional object area.

### TECHNICAL FIELD

The present invention relates to an operation support system. In particular, the present invention relates to a technology for estimating, from a result of shooting by a camera fitted to a mobile object, a three-dimensional object area, i.e. an area where a three-dimensional object appears. The present invention also relates to a vehicle employing such an operation support system.

### BACKGROUND ART

A three-dimensional object standing on a road surface can be an obstacle to a vehicle, and driver's overlooking it may lead to a collision accident. Such collision accidents are particularly likely to occur in the blind spots of drivers. Thus there has been proposed a technique according to which a vehicle is fitted with a camera for monitoring areas that tend to be the driver's blind spots so that an image obtained from the camera is displayed on a display device disposed near the driver's seat. There has also been developed a technology for converting a camera image obtained from a camera into a bird's eye view image for display. The bird's eye view image is an image of a vehicle as viewed from up in the sky, and displaying it makes it easier for the driver to have the sense of distance to a three-dimensional object.

There has also been developed a technique for detecting a three-dimensional object around a vehicle by using an image processing technology and a sensor. Such a technique is advantageous, because the capability of detecting three-dimensional objects around a vehicle makes it possible, for example, to show the presence of a three-dimensional object on a display device and output an alarm according to a detection result of the three-dimensional object.

There has been proposed a technique of using a stereo camera to detect three-dimensional objects around a vehicle. However, use of a stereo camera itself, which is composed of two cameras, invites a cost increase. Also, the positions and angles of the two cameras need to be adjusted with high accuracy, and this makes it troublesome to introduce the technique.

In view of the above, there has been disclosed a technique for detecting a three-dimensional object around a vehicle by use of a monocular camera, for example, in Patent Document 1. According to this technique, camera motion parameters are obtained by a method of least squares by use of information of five or more feature points on a road surface, and based on the thus obtained camera motion parameters, bird's eye view images of adjacent frames are superimposed on each other, to thereby detect a three-dimensional object that appears to be rising up from the road surface in an image.

Patent Document 1: JP-A-2003-44996

### DISCLOSURE OF THE INVENTION

### Problems to be Solved by the Invention

Recognition of feature points on a road surface is essential in order to detect a three-dimensional object according to the technique disclosed in Patent Document 1. A large number of feature points extracted from an image obtained from a camera include feature points on a road surface, but inconveniently, the fact is that no method is proposed for determining whether each feature point extracted from the image is one on the road surface or one on a three-dimensional object. As a result, it is impossible, with the technique disclosed in Patent Document 1, to estimate a three-dimensional area in an image with desired accuracy. Furthermore, a complicated operation is required to obtain the camera motion parameters by the method of least squares using information of five or more feature points on a road surface, and this hinders the realization of a simple system structure.

In view of the foregoing, an object of the present invention is to provide an operation support system and a method for estimating a three-dimensional object area capable of estimating, with desired accuracy, a three-dimensional object area based on an image obtained from a camera. Another object of the present invention is to provide a vehicle employing such a system and a method.

### Means for Solving the Problem

According to one aspect of the present invention, an operation support system is provided with a camera fitted to a mobile object to shoot surroundings of the mobile object, and which estimates, based on camera images on a camera coordinate plane obtained from the camera, a three-dimensional object area in an image based on the camera image. Here, the operation support system comprises: an image acquisition portion which acquires first and second camera images shot by the camera at first and second time points, respectively, while the mobile object is moving, the first and second time points being different from each other; a movement vector detection portion which extracts n feature points (where n is an integer of 2 or more) from the first camera image, and which also detects movement vectors, on the camera coordinate plane, of the feature points between the first and second camera images; a bird's eye conversion portion which projects the camera images, and the feature points and the movement vectors on the camera coordinate plane onto a bird's eye view coordinate plane which is parallel to ground to thereby convert the first and second camera images into first and second bird's eye view images, respectively, and detect positions of the feature points on the first bird's eye view image and movement vectors of the feature points on the bird's eye view coordinate plane between the first and second bird's eye view images; a determination portion which determines, by use of a restraint condition for a ground feature point located on the ground to satisfy, whether or not a target feature point on the first bird's eye view image is the ground feature point; a movement information estimation portion which estimates movement information of the mobile object between the first and second time points based on positions on the first bird's eye view image, and movement vectors on the bird's eye view coordinate plane, of two or more feature points which are each judged as the ground feature point; and a three-dimensional object area estimation portion which estimates the three-dimensional object area based on the first and second bird's eye view images and the movement information.

This makes it possible to detect a ground feature point, and thus desirably accurate estimation of a three-dimensional object area can be expected.

Specifically, for example, the restraint condition may define a relationship which should be satisfied by a rotation angle and a parallel movement amount of the mobile object between the first and second time points and a position on the first bird's eye view image, and a movement vector on the bird's eye view coordinate plane, of the ground feature point.

For further example, the determination portion may extract, as target feature points, two or more feature points from among the n feature points on the first bird's eye view image, and determine whether or not the target feature points are each the ground feature point by determining whether or not the target feature points satisfy the restraint condition.

Further specifically, for example, the determination portion may extract, as target feature points, two or more feature points from among the n feature points on the first bird's eye view image, obtain two or more estimation values of the rotation angle and two or more estimation values of the parallel movement amount by applying the two or more target feature points to the relationship, on an assumption that the two or more target feature points are each the ground feature point, and determine whether or not the target feature points are each the ground feature point, based on a variation among the estimation values of the rotation angle and a variation among the estimation values of the parallel movement amount.

For further example, the movement information may include information which indicates the rotation angle and the parallel movement amount of the mobile object.

Specifically, for example, the three-dimensional object area estimation portion may correct, based on the movement information, displacement between the first and second bird's eye view images attributable to the mobile object moving between the first and second time points, and estimate the three-dimensional object area based on a comparison result between the first and second bird's eye view images after the displacement is corrected.

Specifically, for example, the three-dimensional object area which is estimated may correspond to an area where a three-dimensional object appears in the first camera image, in the second camera image, in the first bird's eye view age, or in the second bird's eye view image.

According to another aspect of the present invention, a vehicle is provided with any one of the above-described operation support systems.

According to another aspect of the present invention, a three-dimensional object area estimation method is a method for estimating, based on a camera image on a camera coordinate plane obtained from a camera fitted to a mobile object to shoot surroundings of the mobile object, a three-dimensional object area in an image based on the camera image. Here, the three-dimensional object area estimation method comprises: an image acquisition step for acquiring first and second camera images shot by the camera at first and second time points, respectively, while the mobile object is moving, the first and second time points being different from each other; a movement vector detection step for extracting n feature points (where n is an integer of 2 or more) from the first camera image, and detecting movement vectors of the feature points on the camera coordinate plane between the first and second camera images; a bird's eye conversion step for projecting the camera images, and the feature points and the movement vectors on the camera coordinate plane onto a bird's eye view coordinate plane which is parallel to ground, to thereby convert the first and second camera images into first and second bird's eye view images, respectively, and detect positions of the feature points on the first bird's eye view image and movement vectors of the feature points on the bird's eye view coordinate plane between the first and second bird's eye view images; a determination step for determining, by use of a restraint condition for a ground feature point located on the ground to satisfy, whether or not a target feature point on the first bird's eye view image is the ground feature point; a movement information estimation step for estimating movement information of the mobile object between the first and second time points based on positions on the first bird's eye view image, and movement vectors on the bird's eye view coordinate plane, of two or more feature points which are each judged as the ground feature point; and a three-dimensional object area estimation step for estimating the three-dimensional object area based on the first and second bird's eye view images and the movement information.

### ADVANTAGES OF THE INVENTION

According to the present invention, it is possible to estimate a three-dimensional object area with desirable accuracy based on an image obtained from a camera.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF DRAWINGS

FIG. 1 is a configuration block diagram of an operation support system embodying the present invention;

FIG. 2 is an exterior side view of a vehicle to which the operation support system of FIG. 1 is applied;

FIG. 3 is a diagram showing the relationship between the optical center of a camera and the camera coordinate plane on which a camera image is defined;

FIG. 4 is a diagram showing the relationship between a camera coordinate plane and a bird's eye view coordinate plane;

FIG. 5 is a flow chart showing the steps in a three-dimensional object area estimation operation according to the operation support system of FIG. 1;

FIGS. 6 (a) and (b) are diagrams showing examples of camera images at time points t1 and t2, respectively;

FIG. 7 is a diagram corresponding to FIGS. 6(a) and 6(b), showing movement vectors of feature points on the camera coordinate plane between time points t1 and t2;

FIGS. 8 (a) and (b) are diagrams showing examples of bird's eye view images at time points t1 and t2, respectively;

FIG. 9 is a diagram corresponding to FIGS. 8(a) and 8(b), showing movement vectors of feature points on the bird's eye view coordinate plane between time points t1 and t2;

FIG. 10 (a) is a diagram showing a camera image obtained while a vehicle is moving straight backward with a group of movement vectors on a camera coordinate plane superimposed on the camera image, and (b) is a diagram showing a bird's eye view image with a projection result of projecting the group of movement vectors onto the bird's eye view image superimposed thereon;

FIG. 11 (a) is a diagram showing a camera image obtained while a vehicle is moving backward while making a turn, with a group of movement vectors on a camera coordinate plane superimposed on the camera image, and (b) is a diagram showing a bird's eye view image with a projection result of projecting the group of movement vectors onto the bird's eye view image superimposed thereon;

FIG. 12 is a plan view showing how a vehicle moves between time points t1 and t2;

FIG. 13 is a diagram showing how a bird's eye view coordinate system at time point t1 and a bird's eye view coordinate system at time point t2 are arranged in the space with respect to each other;

FIG. 14 is a detailed flow chart of ground-feature-point-extracting processing corresponding to step S16 in FIG. 15;

FIG. 15 is a diagram showing the relationship between two target feature points in the ground-feature-point-extracting processing in FIG. 14;

FIG. 16 (a) to (d) are a diagram showing a bird's eye view image at time point t1, a reference image obtained by geometrically converting the bird's eye view image at time point t1 so as to cancel the displacement between bird's eye view images at time points t1 and t2, the bird's eye view image at time point t2, and a differential image between the bird's eye view image at time point t2 and the reference image, respectively;

FIG. 17 is a diagram showing a binarized image obtained by binarizing the differential image shown in FIG. 16(d);

FIG. 18 is a diagram showing a three-dimensional object area extracted from the binarized image shown in FIG. 17;

FIG. 19 is a diagram showing an example of an image displayed on a display device shown in FIG. 1;

FIG. 20 is a diagram showing how the entire region of an image is divided into a plurality of small blocks in a second example of the present invention;

FIGS. 21 (a) and (b) are diagrams showing color-space histograms of corresponding small blocks in the second example of the present invention;

FIGS. 22 (a) and (b) are diagrams showing edge-intensity histograms of corresponding small blocks in the second example of the present invention;

FIGS. 23 (a) and (b) are diagrams showing edge-direction histograms of corresponding small blocks in the second example of the present invention;

FIG. 24 (a) is a diagram showing a differential image in the second example, and (b) is a diagram showing the image shown in FIG. 16(c) with component blocks as candidates for components of a three-dimensional object area superimposed on the image; and

FIG. 25 is a functional block diagram of an operation support system of a third example of the present invention.

### LIST OF REFERENCE SYMBOLS

1 camera
2 image processing device
3 display device
11 image acquisition portion
12 movement detection portion
13 bird's eye conversion portion
14 ground feature point extraction portion
15 vehicle movement information generation portion
16 three-dimensional object area estimation portion
17 display image generation portion
100 vehicle

### BEST MODE FOR CARRYING OUT THE INVENTION

Hereinafter, embodiments of the present invention will be described specifically with reference to the drawings. Among different drawings referred to in the course of description, the same parts are identified by the same reference signs, and in principle no overlapping description of the same parts will be repeated. Prior to the descriptions of practical examples (Examples 1 to 3), the features common to them, or referred to in their descriptions, will be described first.

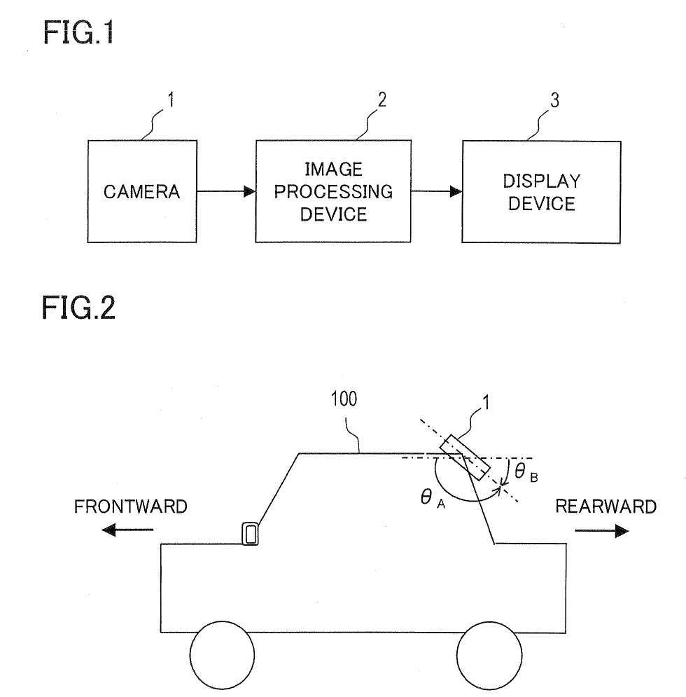

FIG. 1 is a configuration block diagram of an operation support system embodying the present invention. The operation support system of FIG. 1 is provided with a camera 1 as a monocular camera, an image processing device 2, and a display device 3. The camera 1 performs shooting, and outputs a signal representing an image obtained by the shooting to the image processing device 2. The image processing device 2 generates a display image from the image obtained from the camera 1. The image processing device 2 outputs a video signal representing the generated display image to the display device 3. According to the video signal fed to it, the display device 3 displays the display image as video.

An image obtained by the shooting performed by the camera 1 is called a camera image. A camera image represented by the output signal as it is of the camera 1 is often under the influence of lens distortion. Accordingly, the image processing device 2 performs lens distortion correction on a camera image represented by the output signal as it is of the camera 1, and then generates a display image based on the camera image that has undergone the lens distortion correction. In the following description, a camera image refers to one that has undergone lens distortion correction. Depending on the characteristics of the camera 1, however, lens distortion correction may be omitted.

FIG. 2 is an exterior side view of a vehicle 100 to which the operation support system of FIG. 1 is applied. As shown in FIG. 2, the camera 1 is arranged on a rear portion of the vehicle 100 so as to point rearward, obliquely downward. The vehicle 100 is, for example, an automobile. The optical axis of the camera 1 forms two angles with the horizontal plane, specifically angles represented by θ_{A} and θ₁₃, respectively, in FIG. 2. The angle θ_{B} is what is generally called an angle of depression, or a dip. The angle θ_{A} is taken as the inclination angle of the camera 1 relative to the horizontal plane. Here, 90°<θ_{A}<180° and simultaneously θ_{A}+θ_{B}=180°.

The camera 1 shoots the surroundings of the vehicle 100. The camera 1 is installed on the vehicle 100 so as to have a field of view, in particular, rearward of the vehicle 100. The field of view of the camera 1 covers the road surface located rearward of the vehicle 100. In the following description, it is assumed that the ground lies on the horizontal plane, and that a “height” denotes one relative to the ground. Moreover, in the embodiment under discussion, the ground is synonymous with a road surface.

Used as the camera 1 is a camera employing a solid-state image-sensing device such as a CCD (charge-coupled device) or CMOS (complementary metal oxide semiconductor) image sensor. The image processing device 2 is formed with, for example, an integrated circuit. The display device 3 is formed with a liquid crystal display panel, etc. A display device included in a car navigation system or the like may be shared as the display device 3 in the operation support system. The image processing device 2 may be integrated into a car navigation system as a part thereof. The image processing device 2 and the display device 3 are installed, for example, near the driver's seat in the vehicle 100.

The image processing device 2, by use of coordinate conversion, converts a camera image into an image as seen from the point of view of a virtual camera, and thereby generates a bird's eye view image. The coordinate conversion for generating a bird's eye view image from a camera image is called “bird's eye conversion”.

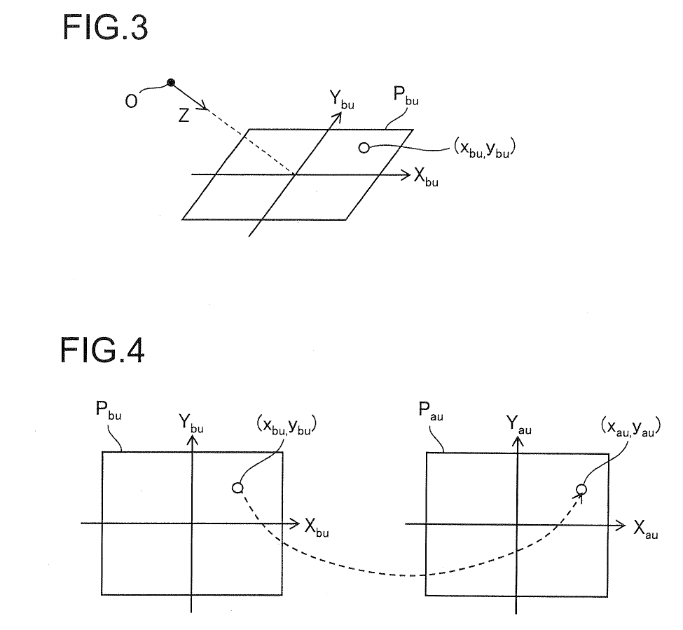

A plane perpendicular to the direction of the optical axis of the camera 1 is taken as a camera coordinate plane. In FIG. 3, the camera coordinate plane is represented by a plane P_{bu}. The camera coordinate plane is a plane onto which a camera image is projected, and is parallel to the sensing surface of the solid-state image-sensing device. A camera image is formed by pixels arranged two-dimensionally on the camera coordinate plane. The optical center of the camera 1 is represented by O, and the axis passing through the optical center O and parallel to the direction of the optical axis of the camera 1 is defined as a Z axis. The intersection between the Z axis and the camera coordinate plane is taken as the origin of the camera image, and two axes lying on the camera coordinate plane and perpendicularly intersecting each other at that origin are defined as the X_{bu} and Y_{bu} axes. The X_{bu} and Y_{bu} axes are parallel to the horizontal and vertical directions, respectively, of the camera image. The position of a given pixel on the camera image is represented by its coordinates (x_{bu}, y_{bu}). The symbols x_{bu} and y_{bu} represent the horizontal and vertical positions, respectively, of the pixel on the camera image.

On the other hand, a plane parallel to the ground is taken as a bird's eye view coordinate plane. FIG. 4 shows a plane Pₐᵤ representing a bird's eye view coordinate plane, as well as the plane P_{bu} representing the camera coordinate plane. A bird's eye view image is formed by pixels arranged two-dimensionally on the bird's eye view coordinate plane. The perpendicular coordinate axes on the bird's eye view coordinate plane are defined as the Xₐᵤ and Yₐᵤ axes. The Xₐᵤ and Yₐᵤ axes are parallel to the horizontal and vertical directions, respectively, of the bird's eye view image. The position of a given pixel on the bird's eye view image is represented by its coordinates (xₐᵤ, yₐᵤ). The symbols xₐᵤ and yₐᵤ represent the horizontal and vertical positions, respectively, of the pixel on the bird's eye view image.

A bird's eye view image is a result of a camera image, which is defined on the camera coordinate plane, being projected onto the bird's eye view coordinate plane, and the bird's eye conversion for carrying out such projection can be achieved by one of known methods of coordinate conversion. For example, perspective projection conversion may be used, in which case a bird's eye view image can be generated by converting, according to formula (A-1) below, the coordinates (x_{bu}, y_{bu}) of each pixel on a camera image into coordinates (xₐᵤ, yₐᵤ) on the bird's eye view image. Here, the symbols f, h, and H represent, respectively, the focal length of the camera 1, the height at which the camera 1 is arranged, and the height at which the above-mentioned virtual camera is arranged. It is here assumed that the image processing device 2 previously knows the values of f, h, H, and θ_{A} (see FIG. 2).

$$\begin{matrix}[ Formula 1 ] & \\ ( \begin{matrix}{x}_{au} \\ {y}_{au}\end{matrix} ) = ( \begin{matrix}\frac{{x}_{bu} ( fh sin {θ}_{A} + {Hy}_{au} cos {θ}_{A} )}{fH} \\ \frac{fh ( f cos {θ}_{A} - {y}_{bu} sin {θ}_{A} )}{H ( f sin {θ}_{A} + {y}_{bu} cos {θ}_{A} )}\end{matrix} ) & ( A \text{-} 1 )\end{matrix}$$

In practice, beforehand, according to formula (A-1), a table data is created which shows the correspondence between the coordinates (x_{bu}, y_{bu}) of each pixel on the camera image and the coordinates (xₐᵤ, yₐᵤ) of each pixel on the bird's eye view image, and the table data is stored in an unillustrated memory to form a lookup table (hereinafter referred to as the “bird's eye conversion LUT”). In actual operation, by use of the bird's eye conversion LUT, a camera image is converted into a bird's eye view image. Needless to say, a bird's eye view image may be generated by performing coordinate conversion calculation based on formula (A-1) each time a camera image is obtained.

The operation and structure of the operation support system of FIG. 1 will be described in detail below by way of practical examples, namely Examples 1 to 3. Unless inconsistent, any feature in one of these Examples is applicable to any other.

### Example 1

First, Example 1 will be described. The image processing device 2 shown in FIG. 1 acquires camera images at a predetermined cycle from the camera 1, generates display images one after another from the camera images thus acquired one after another, and keeps outputting the latest display image to the display device 3. Thereby, the display device 3 displays the latest display image in a constantly updated fashion.

The image processing device 2 is provided with a function of estimating a three-dimensional object area within an image. A three-dimensional object area denotes an area in which a three-dimensional object appears. A three-dimensional object is an object with height, such as a person. Any object without height, such as a road surface forming the ground, is not a three-dimensional object. A three-dimensional object can be an obstacle to the traveling of the vehicle 100.

In bird's eye conversion, coordinate conversion is so performed that a bird's eye view age has continuity on the ground surface. Accordingly, when two bird's eye view images are obtained by the shooting of a single three-dimensional object from different viewpoints, in principle, whereas the image of the road surface coincides between the two bird's eye view images, the image of the three-dimensional object does not (see, for example, JP-A-2006-268076). This characteristic is utilized in this example to estimate a three-dimensional object area.

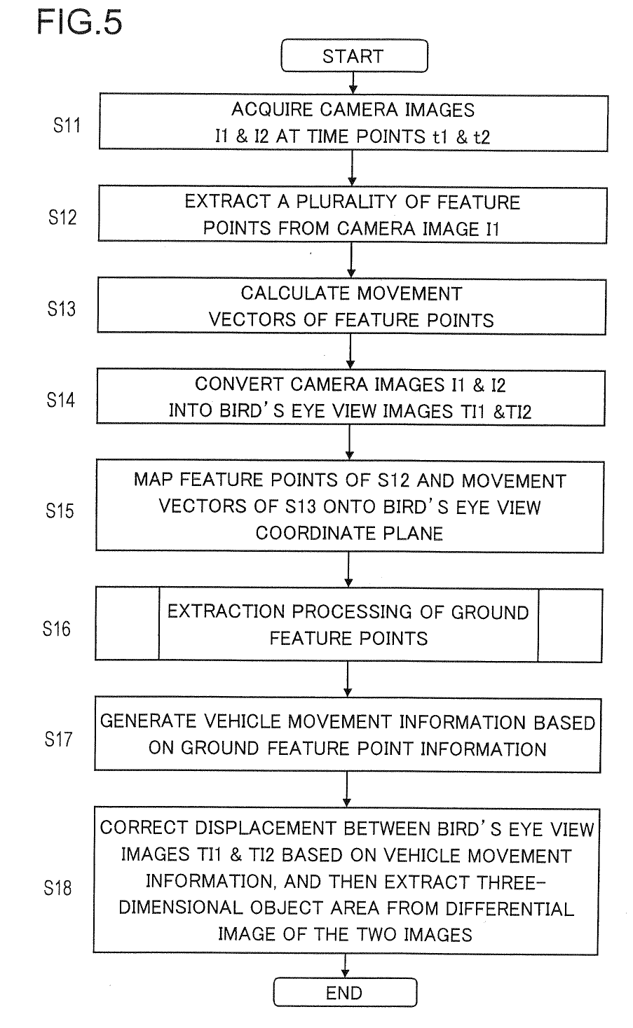

With reference to FIG. 5, a method of estimating a three-dimensional object area will now be described. FIG. 5 is a flow chart showing the operation procedure of this estimation. The processing in steps S11 through S18 shown in FIG. 5 is executed by the image processing device 2 of FIG. 1.

Estimating a three-dimensional object area requires a plurality of camera images shot at different time points. Accordingly, in step S11, the image processing device 2 acquires a plurality of camera images shot at different time points. Here, it is assumed that the thus acquired camera images include one shot at time t1 (hereinafter called camera image at time point t1) and one shot at time point t2 (hereinafter called camera image at time point t2). The camera images at time points t1 and t2 will now be referred to as the camera images I1 and I2, respectively. It is also assumed that time point t1 comes before time point t2. More precisely, for example, time point t1 is the midpoint of the exposure period of the camera image I1, and time point t2 is the midpoint of the exposure period of the camera image I2. It is further assumed that, during the period between time points t1 and t2, the vehicle 100 moves. Accordingly, the viewpoint of the camera 1 differs between at time t1 and at time t2.

After the camera images I1 and I2 are acquired, at step S12, a plurality of (for example, a thousand) feature points are extracted from the camera image I1. A feature point is a point which is distinguishable from surrounding points and easy to track. Such a feature point can be extracted automatically by use of a well-known feature point extractor (unillustrated) which detects a pixel where density greatly varies in the horizontal and vertical directions. Examples of such a feature point extractor include the Harris corner detector, and the SUSAN corner detector. As feature points to be extracted, for example, an intersection or an end point of white lines drawn on a road surface, a stain or a crack of a road surface, and an end portion or a strain of a three-dimensional object are expected.

In step S13 following step S12, the camera image I1 and the camera image I2 are compared with each other to obtain movement vectors of the feature points extracted in step S12. The movement vectors obtained here are each a movement vector, on the camera coordinate plane, between the camera image I1 and the camera image I2 (in other words, between time points t1 and t2). The movement vector of a feature point between two images shows in which direction and how much the feature point has moved between the two images. Here, movement vectors are obtained by use of the publicly-known hierarchization Lucas & Kanade algorithm which is capable of dealing with a large amount of movement. Needless to say, a block matching method or a gradient method may be used to obtain movement vectors. A movement vector is generally called an optical flow vector or a motion vector as well.

In step S14 following step S13, the camera images acquired in step S11 are converted into bird's eye view images according to the bird's eye conversion LUT based on formula (A-1) above. The bird's eye view images based on the camera images I1 and I2 are called the bird's eye view images at time points t1 and t2, respectively, and the bird's eye view images at time points t1 and t2 will now be referred to as the bird's eye view images TI1 and TI2, respectively. The bird's eye view images TI1 and TI2 correspond to images resulting from projecting the camera images I1 and I2, respectively, onto the bird's eye view coordinate plane.

In step S15 following step S14, the feature points extracted from the camera image I1 in step S12 and the movement vectors calculated in step S13 are mapped (in other words, projected) onto the bird's eye view coordinate plane. This mapping is also performed according to the bird's eye conversion LUT based on the above-described formula (A-1) (or according to formula (A-1) itself). By this mapping, the feature points on the camera image I1 are mapped on the bird's eye view image TI1, and thereby the positions of the feature points (that is, the coordinate values (x_{bu}, y_{bu}) of the feature points) on the bird's eye view image TI1 are obtained, and also, the movement vectors on the camera coordinate plane are mapped on the bird's eye view coordinate plane, and thereby the movement vectors of the feature points on the bird's eye view coordinate plane are obtained. Needless to say, the movement vectors obtained here are each a movement vector between the bird's eye view image TI1 and the bird's eye view image T12 (in other words, between time points t1 and t2).

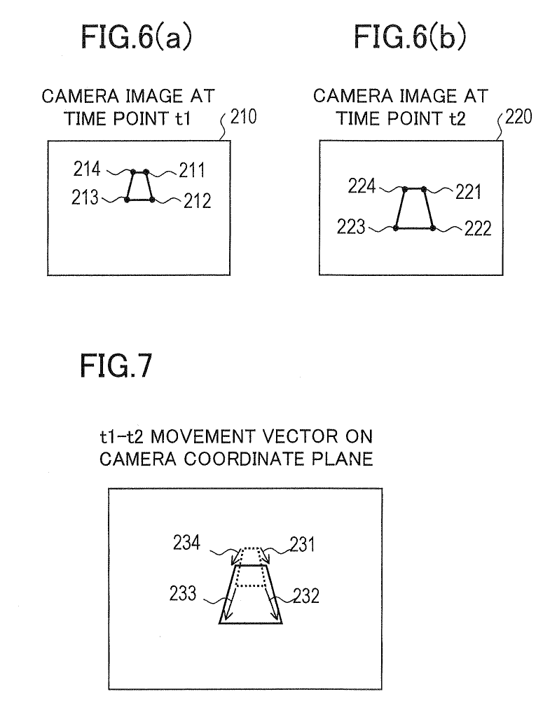

An image 210 of FIG. 6(a) and an image 220 of FIG. 6(b) show an example of the camera image I1 and an example of the camera image I2, respectively. Points 211 to 214 in the image 210 indicate first to fourth feature points extracted from the image 210 in step S12. The feature points 211 to 214 correspond to four corners of a white square line drawn on the road surface. Points 221 to 224 in the image 220 indicate feature points in the image 220 that correspond to the feature points 211 to 214. It is assumed that the images 210 and 220 are acquired while the vehicle 100 is moving straight backward. Shown in FIG. 7 are movement vectors 231 to 234 of first to fourth feature points on the camera coordinate plane obtained by comparison between the images 210 and 220 as the camera images I1 and I2, respectively. In FIG. 7, the white line in the image 210 is shown by a dotted line, and the white line in the image 220 is shown by a solid line in a superimposed manner (the same is applied to FIG. 9 which will be described later).

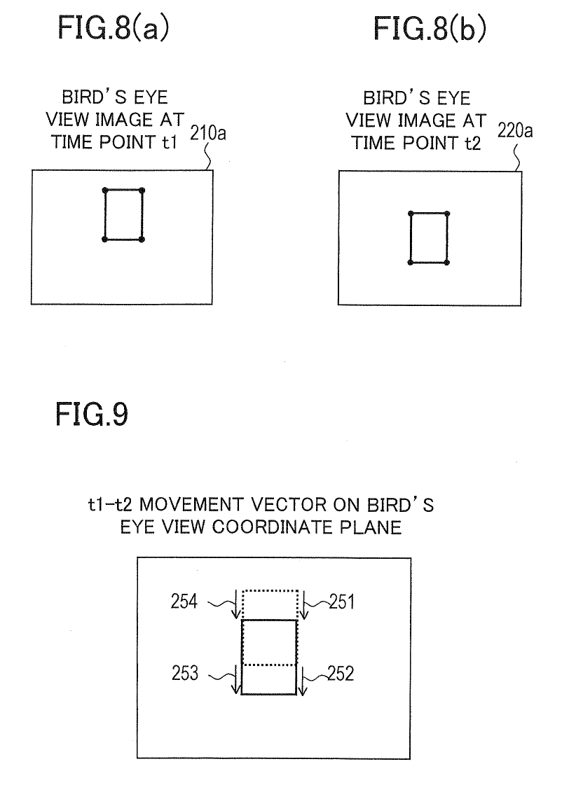

An image 210a of FIG. 8(a) and an image 220a of FIG. 8(b) are bird's eye view images based on the image 210 of FIG. 6(a) and the image 220 of FIG. 6(b), respectively. Movement vectors 251 to 254 in FIG. 9 are obtained by mapping (in other words, projecting) the movement vectors 231 to 234 in FIG. 7 onto the bird's eye view coordinate plane.

As is clear from FIG. 7 as well, although the vehicle 100 is moving straight backward, movement vectors of the feature points on the road surface are not uniform in magnitude and direction. In contrast, on the bird's eye view coordinate plane, the movement vectors are uniform in magnitude and direction (see FIG. 9).

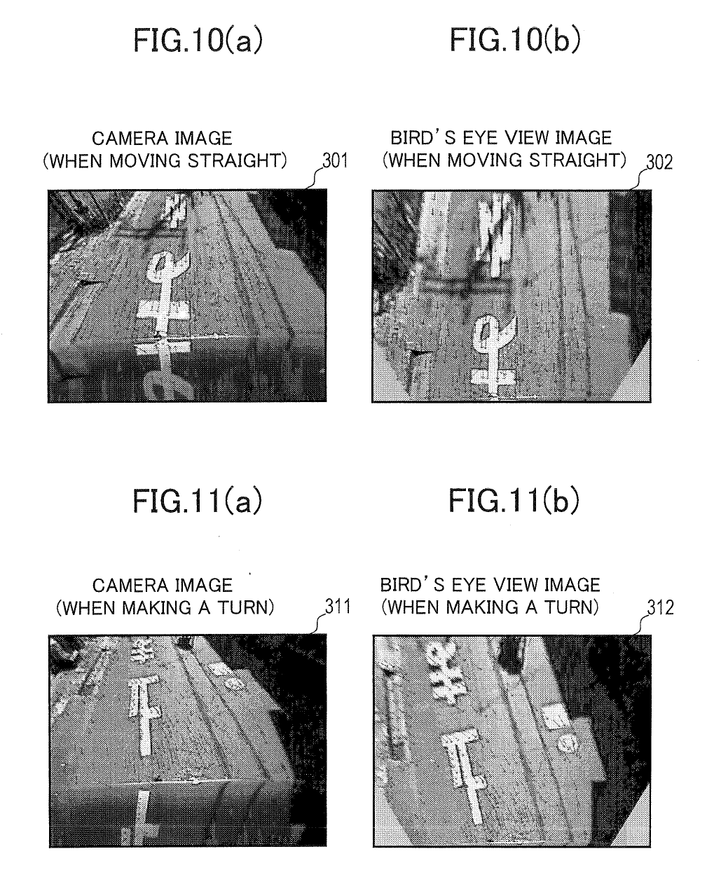

FIGS. 10(a) and 10(b) and FIGS. 11(a) and 11(b) are examples of an image based on an actual camera image. An image 301 of FIG. 10(a) shows a camera image obtained while the vehicle 100 is moving straight backward, with a group of movement vectors on the camera coordinate plane superimposed thereon, and an image 302 of FIG. 10(b) shows a bird's eye view image with a result of projecting the movement vectors onto the bird's eye view coordinate plane superimposed thereon. In the lower part of the image 301, a trunk portion of the vehicle 100 is described. Between FIGS. 10(a) and 10(b) as well, there can be observed the same difference in uniformity among the movement vectors as seen between FIG. 7 and FIG. 9. An image 311 of FIG. 11(a) shows a camera image obtained while the vehicle 100 is moving backward while making a turn, with a group of movement vectors on the camera coordinate plane superimposed thereon, an image 312 of FIG. 11(b) shows a bird's eye view image, with a result of projecting the group of movement vectors onto the bird's eye view coordinate plane superimposed thereon.

As mentioned above, if given two target feature points are located on the ground surface, the movement vectors of the two feature points on the bird's eye view coordinate plane are uniform. However, if the feature points are located on a three-dimensional object, such uniformity between the movement vectors is, in principle, broken. In step S16 following step S15, this characteristic is used to extract feature points located on the ground surface. Hereinafter, a feature point located on the ground surface will be referred to as a ground feature point, and a feature point located on a three-dimensional object will be referred to as a three-dimensional object feature point. In the real space, ground feature points are located at zero height (or practically zero height), and feature points which are not classified as the ground feature point are all three-dimensional object feature points.

The principle of the processing performed in step S16 will now be described. Note that, in the description below, a movement vector means a movement vector on the bird's eye view coordinate plane between time points t1 and t2, unless otherwise stated.

Now, attention is focused on a target ground feature point, and the coordinate values (xₐᵤ, yₐᵤ) of the target ground feature point on the bird's eye view images TI1 and TI2 are represented by (x₁, y₁) and (x₂, y₂), respectively. The movement vector of the target ground feature point is represented by (fₓ, f_{y}), where fₓ and f_{y} are a horizontal component (that is to say, Xₐᵤ axis component) and a vertical component (that is to say, Yₐᵤ axis component), respectively, of the movement vector (see FIG. 4). Then, the following formula (B-1) holds.

$$\begin{matrix}[ Formula 2 ] & \\ ( \begin{matrix}{f}_{x} \\ {f}_{y}\end{matrix} ) = ( \begin{matrix}{x}_{2} \\ {y}_{2}\end{matrix} ) - ( \begin{matrix}{x}_{1} \\ {y}_{1}\end{matrix} ) & ( B \text{-} 1 )\end{matrix}$$

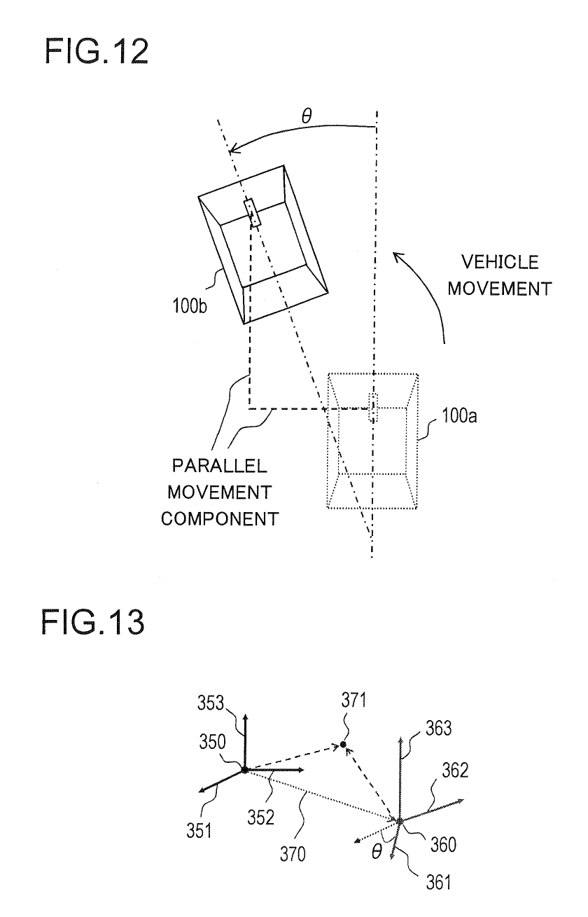

Furthermore, it is assumed that the vehicle 100 is moving while making a turn between time points t1 and t2 as shown in FIG. 12, and the rotation angle of the thus moving vehicle 100 is represented by θ. The rotation angle θ is equal to an angle formed by the optical axis of the camera 1 at time point t1 and that at time point t2. Movement of the vehicle 100 is composed of a parallel movement component and a rotation component represented by the rotation angle θ. FIG. 12 is a plan view showing the vehicle 100 as seen from above, and a vehicle drawn with a broken line 100a is the vehicle 100 at time point t1, and a vehicle drawn with a solid line 100b is the vehicle 100 at time point t2. The camera 1 is fixed to a particular portion of the vehicle 100, and accordingly moves, along with the movement of the vehicle 100, the same distance as the vehicle 100 moves.

On the other hand, a three-dimensional orthogonal coordinate system having its origin set at the optical center of the cameral 1 will be considered. FIG. 13 shows how a three-dimensional orthogonal coordinate system at time t1 and a three-dimensional orthogonal coordinate system at time t2 are arranged in the space with respect to each other. In the three-dimensional orthogonal coordinate system at time point t1, coordinate axes 351, 352, and 353 are orthogonal to one another, and the origin 350 at which the axes 351, 352, and 353 intersect one another is set at the optical center of the camera 1 at time point t1. In the three-dimensional orthogonal coordinate system at time point t2, coordinate axes 361, 362, and 363 are perpendicular to one another, and the origin 360 at which the axes 361, 362, and 363 intersect one another is set at the optical center of the camera 1 at time point t2. The axes 351, 352, 361, and 362 are parallel to the road surface, and the axes 353 and 363 are perpendicular to the road surface. The three axes of the three-dimensional orthogonal coordinate system varies from the axes 351, 352, and 353 to the axes 361, 362, and 363, respectively, with the movement of the vehicle 100 between time points t1 and t2.

A point 371 in FIG. 13 represents the target ground feature point fixed on a world coordinate system. A ground feature point on the real space is projected onto a bird's eye view coordinate plane to become a ground feature point on a bird's eye view image. A dotted arrow 370 represents the parallel movement amount of the vehicle 100 and the camera 1 between time points t1 and t2. The parallel movement amount is a two-dimensional vector quantity, which may also be called a parallel movement vector. The three-dimensional orthogonal coordinate system at time point t2 results from parallelly moving the three-dimensional orthogonal coordinate system at time point t1 by the parallel movement amount and then turning it by the rotation angle θ around an axis which is perpendicular to the road surface. The parallel movement amount of a ground feature point on the bird's eye coordinate plane along with the movement of the vehicle 100 between time points t1 and t2 is represented by (Tₓ, T_{y}). Tₓ and T_{y} are a horizontal component (that is, Xₐᵤ axis component) and a vertical component (that is, Yₐᵤ axis component), respectively, of the parallel movement amount of a ground feature point on the bird's eye view coordinate plane.

The above-described rotation angle θ and the parallel movement amount (Tₓ, T_{y}) satisfy the relationship represented by the following formula (B-2).

$$\begin{matrix}[ Formula 3 ] & \\ ( \begin{matrix}{x}_{2} \\ {y}_{2}\end{matrix} ) = ( \begin{matrix}cos θ & - sin θ \\ sin θ & cos θ\end{matrix} ) ( \begin{matrix}{x}_{1} \\ {y}_{1}\end{matrix} ) + ( \begin{matrix}{T}_{x} \\ {T}_{y}\end{matrix} ) & ( B \text{-} 2 )\end{matrix}$$

The camera images I1 and I2 are normally two temporally adjacent frames which are serially acquired. Thus, when the vehicle 100 moves at a low speed or when the frame rate is sufficiently high, it is possible to consider that cos θ≈1 and sin θ≈θ. By applying these approximate values to formula (B-2), the following formula (B-3) is obtained.

$$\begin{matrix}[ Formula 4 ] & \\ ( \begin{matrix}{x}_{2} \\ {y}_{2}\end{matrix} ) = ( \begin{matrix}1 & - θ \\ θ & 1\end{matrix} ) ( \begin{matrix}{x}_{1} \\ {y}_{1}\end{matrix} ) + ( \begin{matrix}{T}_{x} \\ {T}_{y}\end{matrix} ) & ( B \text{-} 3 )\end{matrix}$$

Furthermore, substituting the above formula (B-1) into formula (B-3) and modifying the resulting formula gives formula (B-4).

$$\begin{matrix}[ Formula 5 ] & \\ θ ( \begin{matrix}{y}_{1} \\ - {x}_{1}\end{matrix} ) - ( \begin{matrix}{T}_{x} \\ {T}_{y}\end{matrix} ) + ( \begin{matrix}{f}_{x} \\ {f}_{y}\end{matrix} ) = 0 & ( B \text{-} 4 )\end{matrix}$$

Here, the values fₓ, f_{y}, y₁, and (−x₁) are obtained from the result of the processing performed in step S15 in FIG. 5. On the other hand, the values of θ, Tₓ, and T_{y} are unknown. With information of the positions and the movement vectors of two ground feature points, it is possible to obtain these three unknown values. This is because θ, Tₓ, and T_{y} for one ground feature point should be the same as θ, Tₓ, and T_{y} for the other ground feature point.

Thus, attention will be focused on two different ground feature points on the bird's eye view image TI1, and the two ground feature points will be referred to as first and second ground feature points. Assume that the coordinate values (xₐᵤ, yₐᵤ) of the first and second ground feature points on the bird's eye view image TI1 are (x₁₁, Y₁₁) and (x₁₂, y₁₂), respectively. In addition, assume that the movement vectors of the first and second ground feature points are represented by (fₓ₁, f_{y1}) and (fₓ₂, f_{y2}), respectively. Then, the following formulae (B-5a) and (B-5b) are obtained from the above formula (B-4). Furthermore, formula (B-6) is obtained from a difference between formulae (B-5a) and (B-5b), and moreover, formulae (B-7a) and (B-7b) are obtained from formula (B-6).

$$\begin{matrix}[ Formula 6 ] & \\ θ ( \begin{matrix}{y}_{11} \\ - {x}_{11}\end{matrix} ) - ( \begin{matrix}{T}_{x} \\ {T}_{y}\end{matrix} ) + ( \begin{matrix}{f}_{x 1} \\ {f}_{y 1}\end{matrix} ) = 0 & ( B \text{-} 5 a ) \\ θ ( \begin{matrix}{y}_{12} \\ - {x}_{12}\end{matrix} ) - ( \begin{matrix}{T}_{x} \\ {T}_{y}\end{matrix} ) + ( \begin{matrix}{f}_{x 2} \\ {f}_{y 2}\end{matrix} ) = 0 & ( B \text{-} 5 b ) \\ [ Formula 7 ] & \\ θ ( \begin{matrix}{y}_{11} - {y}_{12} \\ - {x}_{11} + {x}_{12}\end{matrix} ) + ( \begin{matrix}{f}_{x 1} - {f}_{x 2} \\ {f}_{y 1} - {f}_{y 2}\end{matrix} ) = 0 & ( B \text{-} 6 ) \\ [ Formula 8 ] & \\ θ = \frac{{f}_{x 2} - {f}_{x 1}}{{y}_{11} - {y}_{12}} & ( B \text{-} 7 a ) \\ θ = \frac{{f}_{y 2} - {f}_{y 1}}{{x}_{12} - {x}_{11}} & ( B \text{-} 7 b )\end{matrix}$$

Two values of the rotation angle θ are calculated by use of formulae (B-7a) and (B-7b), and two values of the parallel movement amount (Tₓ, T_{y}) are calculated by substituting the two calculated values of the rotation angle θ respectively into formulae (B-5a) and (B-5b). If the values (x₁₁, y₁₁) and (x₁₂, y₁₂) and the values (fₓ₁, f_{y1}) and (fₓ₂, f_{y2}) are truly related to the ground feature points, the two calculated values of the rotation angle θ are completely or substantially equal to each other, and simultaneously, the two calculated values of the parallel movement amount (Tₓ, T_{y}) are completely or substantially equal to each other. Thus, by checking the agreement of the values with respect to given two feature points on the bird's eye view image TI1, it is possible to determine whether or not the two feature points are ground feature points.

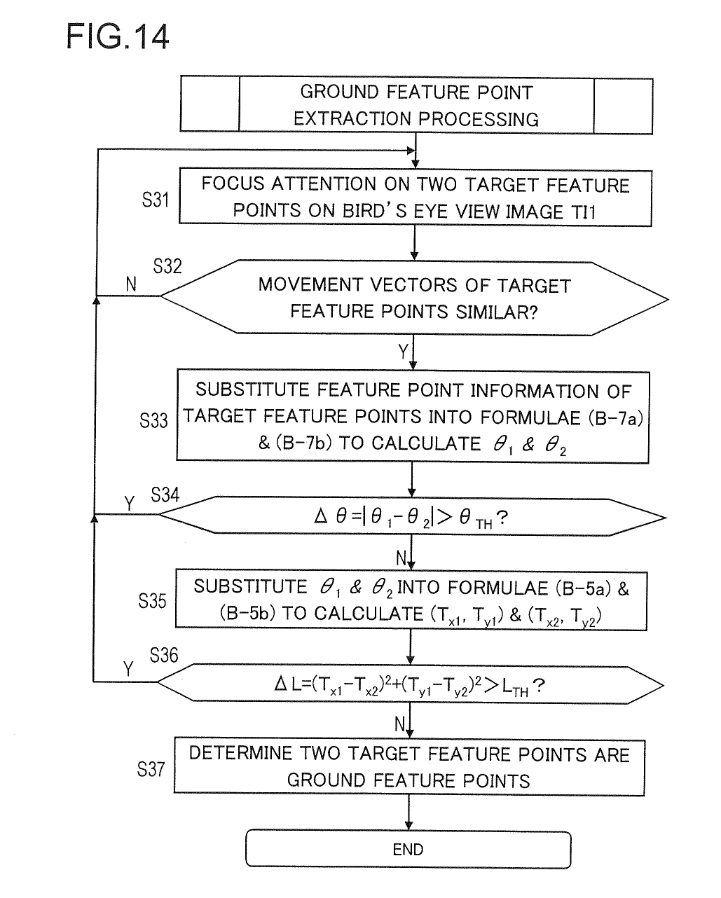

The specific procedure of the processing performed in step S16 in FIG. 5 is as follows. FIG. 14 is a detailed flow chart of the processing performed in step S16. The processing performed in step S16 is composed of steps S31 to S37 shown in FIG. 14.

First, in step S31, two feature points are chosen from a plurality of feature points formed on the bird's eye view image TI1 by the mapping in step S15 in FIG. 5. Here, the two chosen feature points are called target feature points. For example, two feature points which are apart from each other by a certain reference distance or more on the bird's eye view image TI1 are chosen.

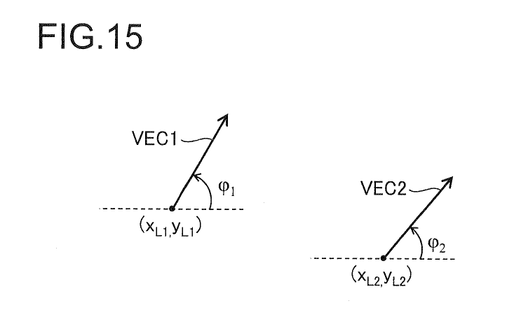

As shown in FIG. 15, coordinate values (xₐᵤ, yₐᵤ) of the two target feature points on the bird's eye view image TI1 are represented by (x_{L1}, y_{L1}) and (x_{L2}, y_{L2}), and movement vectors of the two target feature points are denoted by VEC1 and VEC2. Furthermore, horizontal and vertical components of the movement vector VEC1 are represented by f_{Lx1} and f_{Ly1}, respectively, and horizontal and vertical components of the movement vector VEC2 are represented by f_{Lx2} and f_{Ly2}, respectively.

In the following step S32, it is judged whether or not the movement vectors VEC1 and VEC2 of the two target feature points are similar to each other. The similarity of the movement vectors is assessed in terms of both magnitude and direction. Magnitudes of the vectors VEC1 and VEC2 are denoted by |VEC1| and |VEC2|, respectively. As shown in FIG. 15, an angle formed by the movement vector VEC1 and the horizontal line is denoted by φ₁, and an angle formed by the movement vector VEC2 and the horizontal line is denoted by φ₂. Note that the angles φ₁ and φ₂ are angles which are measured counterclockwise from the horizontal line to the respective corresponding movement vectors. And, for example, if the absolute value of (|VEC1|-|VEC2|) is equal to a predetermined positive threshold value VEC_{TH} or less, and simultaneously |φ₁φ₂| is equal to a predetermined positive threshold value φ_{TH} or less, it is determined that the movement vectors VEC1 and VEC2 are similar to each other, and the process proceeds to step S33; if not, it is determined that the movement vectors VEC1 and VEC2 are not similar to each other and the process returns to step S31, where different feature points are chosen. This is because, if the two vectors are not similar to each other, it can be presumed that at least one of the two target feature points is not a ground feature point.

In step S33, feature point information of the target feature points are substituted into formulae (B-7a) and (B-7b). Here, the feature point information of the target feature points is, for example, information representing the coordinate values (for example, (x_{L1}, y_{L1})) and the movement vectors of the target feature points. That is, in step S33, x_{L1}, y_{L1}, x_{L2}, y_{L2}, f_{Lx1}, f_{Ly1}, f_{Lx2}, and f_{Ly2} are substituted for x₁₁, y₁₁, x₁₂, y₁₂, fₓ₁, f_{y1}, fₓ₂, and f_{y2}, respectively, in formulae (B-7a) and (B-7b). And, θ obtained from formula (B-7a) and θ obtained from formula (B-7b) as a result of this substitution are denoted by θ₁ and θ₂, respectively. θ₁ and θ₂ can be called estimated values of the rotation angle θ obtained on the assumption that the two target feature points are ground feature points.

In step S34 following step S33, it is judged whether or not the absolute value Δθ(=|θ₁−θ₂|) of the difference between θ₁ and θ₂ is larger than a predetermined positive reference angle θ_{TH}, and if the relationship Δθ>θ_{TH} holds, it is presumed that at least one of the two target feature points is not a ground feature point, and the process returns to step S31, where different feature points are chosen. On the other hand, if the relationship Δθ>θ_{TH} does not hold, the process proceeds to step S35, where θ₁ and θ₂ are substituted for θ in formulae (B-5a) and (B-5b), respectively, to obtain the parallel movement amount (Tₓ, T_{y}). In doing so, the feature point information of the target feature points is substituted into formulae (B-5a) and (B-5b). That is, x_{L1}, y_{L1}, x_{L2}, y_{L2}, f_{Lx1}, f_{Lx2}, and f_{Ly2} are substituted for x₁₁, y₁₁, x₁₂, y₁₂, fₓ₁, f_{y1}, fₓ₂, and f_{y2}, respectively, of formulae (B-5a) and (B-5b). The (Tₓ, T_{y}) obtained from formula (B-5a) is represented by (Tₓ₁, T_{y1}), and the (Tₓ, T_{y}) obtained from formula (B-5b) is represented by (Tₓ₂, T_{y2}). (Tₓ₁, T_{y1}) and (Tₓ₂, T_{y2}) can be called estimated values of the parallel movement amount (Tₓ, T_{y}) obtained on the assumption that the two target feature points are ground feature points.

Thereafter, in step S36, ΔL=(Tₓ₁−Tₓ₂)²+(T_{y1}−T_{y2})² is calculated, and it is judged whether or not ΔL is larger than a predetermined positive threshold value L_{TH}. If the relationship ΔL>L_{TH} holds, it is presumed that at least one of the two target feature points is not a ground feature point, and the process returns to step S31, where different feature points are chosen. On the other hand, if the relationship ΔL>L_{TH} does not hold, the process proceeds to step S37, where it is determined that the two currently-chosen target feature points are ground feature points.

When two ground feature points are detected through step S37, the process in FIG. 5 proceeds from step S16 to step S17, where vehicle movement information representing the rotation angle θ and the parallel movement amount (Tₓ, T_{y}) is generated based on the ground feature point information. The ground feature point information is information representing the coordinate values and the movement vectors of feature points judged as ground feature points. Needless to say, the coordinate values are those on the bird's eye view image TI1. As described above, in the case in which two target feature points are set in step S31, vehicle movement information is generated based on the ground feature point information of two feature points. In practice, the vehicle movement information is generated by averaging the two estimated values θ₁ and θ₂ of the rotation angle θ which are already obtained in step S33 in FIG. 14 based on the ground feature point information of two feature points, and by averaging the two sets of estimated values (Tₓ₁, T_{y1}) and (Tₓ₂, T_{y2}) of the parallel movement amount (Tₓ, T_{y}) which are already obtained in step S35 in FIG. 14 based on the ground feature point information of two feature points. That is, the vehicle movement information is generated according to θ=(θ₁+θ₂)/2, Tₓ=(Tₓ₁+Tₓ₂)/2 and T_{y}=(T_{y1}+T_{y2})/2.

With the method described above, two feature points are chosen as the target feature points, but three or more feature points may be chosen as the target feature points. For example, in a case in which four feature points are chosen as the target feature points in step S31 in FIG. 14, the processing is performed as described below. First, it is judged whether or not the movement vectors of the four target feature points are similar to one another, and if it is determined that they are not similar to one another, feature points are chosen anew without the processing of step S33 being performed. If it is determined that they are similar to one another, the four target feature points are divided into first and second groups each composed of two target feature points. The feature point information of the target feature points in the first group is substituted into formulae (B-7a) and (B-7b), and 8 obtained from formula (B-7a) and 8 obtained from formula (B-7b) as a result of the substitution are denoted by θ₁ and θ₂, respectively. On the other hand, the feature point information of the target feature points in the second group is substituted into formulae (B-7a) and (B-7b), and θ obtained from formula (B-7a) and θobtained from formula (B-7b) as a result of the substitution are denoted by θ₃ and θ₄, respectively. Then, according to formula (C-1) below, Δθ₁₋₄ is calculated. That is, Δθ₁₋₄ is obtained as a total amount of |θᵢ˜θⱼ| with respect to (i, j)=(1, 2), (1, 3), (1, 4), (2, 3), (2, 4), and (3, 4).

$$\begin{matrix}[ Formula 9 ] & \\ {Δθ}_{1 \text{-} 4} = {\sum }_{i , j} \vert {θ}_{i} - {θ}_{j} \vert & ( C \text{-} 1 )\end{matrix}$$

If Δθ₁₋₄ is larger than a predetermined positive threshold value, the process returns to step S31, where feature points are chosen anew. If not, on the other hand, the parallel movement amount (Tₓ, T_{y}) is calculated with attention focused on each of the first and second groups. First, with attention focused on the first group, the feature point information of the target feature points of the first group is substituted into formulae (B-5a) and (B-5b), and simultaneously, θ₁ and θ₂ are substituted for θ of formula (B-5a) and θ of formula (B-5b), respectively, to thereby obtain parallel movement amounts (Tₓ, T_{y}). The (Tₓ, T_{y}) obtained from formula (B-5a) is represented by (Tₓ₁, T_{y1}), and the (Tₓ, T_{y}) obtained from formula (B-5b) is represented by (Tₓ₂, T_{y2}). Next, with attention focused on the second group, the feature point information of the target feature points of the second group is substituted into formulae (B-5a) and (B-5b), and simultaneously, θ₃ and θ₄ are substituted for θ of formula (B-5a) and θ of formula (B-5b), respectively, to thereby obtain parallel movement amounts (Tₓ, T_{y}). The (Tₓ, T_{y}) obtained from formula (B-5a) is represented by (Tₓ₃, T_{y3}), and the (Tₓ, T_{y}) obtained from formula (B-5b) is represented by (Tₓ₄, T_{y4}). Then, according to formula (C-2) below, ΔL₁₋₄ is calculated. That is, ΔL₁₋₄ is obtained as a total amount of {(Tₓᵢ−Tₓⱼ)²+(T_{yi}−T_{yj})²} with respect to (i, j)=(1, 2), (1, 3), (1, 4), (2, 3), (2, 4), and (3, 4).

$$\begin{matrix}[ Formula 10 ] & \\ Δ {L}_{1 \text{-} 4} = {\sum }_{i , j} \{ {( {T}_{xi} - {T}_{xj} )}^{2} + {( {T}_{yi} - {T}_{yj} )}^{2} \} & ( C \text{-} 2 )\end{matrix}$$

If ΔL₁₋₄ is larger than the predetermined positive threshold value, the process returns to step S31, where feature points are chosen anew. If not, on the other hand, the process proceeds to step S37, where it is determined that the four target feature points are ground feature points, and by use of θᵢ, Tₓᵢ and T_{yi} (here, i=1, 2, 3, 4) based on the ground feature point information of the four ground feature points, the vehicle movement information is generated according to θ=(θ₁+θ₂+θ₃+θ₄)/4, Tₓ=(Tₓ₁+Tₓ₂+Tₓ₃+Tₓ₄)/4 and T_{y}=(T_{y1}+T_{y2}+T_{y3}+T_{y4})/4.

A detailed discussion will be given of the method of extracting ground feature points described above. The above described formulae (B-5a), (B-5b), (B-7a), and (B-7b) are restraint formulae prescribing relationship which the rotation angle θ and the parallel movement amount (Tₓ, T_{y}), the coordinate values (x₁₁, y₁₁) and (x₁₂, y₁₂) of the ground feature points, and the movement vectors (fₓ₁, f_{y1}) and (fₓ₂, f_{y2}) should satisfy. In other words, these formulae represent a restraint condition which ground feature points should satisfy. With the above-described method, two or more feature points are extracted, from among a group of feature points on the bird's eye view image TI1, as target feature points, and then it is judged whether or not the two or more target feature points (hereinafter, also collectively referred to as target-feature-point group) satisfy the above restraint condition. And, only when the restraint condition is satisfied, it is determined that the target feature points are ground feature points.

In practice, by applying the feature point information of the target feature points to the restraint formulae on the assumption that the target feature points are ground feature points, two or more estimated values (such as θ₁ and θ₂) of the rotation angle are obtained, and simultaneously two or more estimated values (such as (Tₓ₁, T_{y1}) and (Tₓ₂, T_{y2})) of the parallel movement amount are obtained. Then, an indicator (such as Δθ and Δθ₁₋₄ described above) indicating a variation among the estimated values of the rotation angle and an indicator (such as ΔL and ΔL₁₋₄ described above) indicating a variation among the estimated values of the parallel movement amount are calculated, and based on the degrees of the variations, it is judged whether or not the restraint condition is satisfied. Only when the variations among the estimated values of both the rotation angle and the parallel movement amount are comparatively small, it is determined that the restraint condition is satisfied, and the process proceeds to step S37 in FIG. 14.

Incidentally, in the above method, ground feature points are extracted and vehicle movement information is generated on the assumption that the vehicle 100 is rotating (that is, turning) while moving. When the vehicle 100 is moving straight, a rotation angle θ of zero degrees is accordingly obtained. The straight moving state can be taken as a rotation state at the rotation angle θ of zero degrees.

Refer to FIG. 5 again. After the vehicle movement information is generated in step S17, the process proceeds to step S18. As the vehicle 100 moves between time points t1 and t2, the ground feature points on the bird's eye view coordinate plane also move. The rotation angle and the parallel movement amount in the movement of the ground feature points are consistent with the rotation angle θ and the parallel movement amount (Tₓ, T_{y}), which are represented by the vehicle movement information, and at the same time, indicate displacement (displacement on the ground) between the bird's eye view images TI1 and TI2, which is attributable to the movement of the vehicle 100 between time points t1 and t2. Thus, in step S18, a differential image DI between the bird's eye view images TI1 and TI2 is generated after the displacement is corrected based on the vehicle movement information. Then, based on a principle that road surface images are identical but three-dimensional object images are not identical between two bird's eye view images shot from different viewpoints, a three-dimensional object area is extracted from the differential image DI.

More specifically, geometric conversion by use of the rotation angle θ and the parallel movement amount (Tₓ, T_{y}) is applied to the bird's eye view image TI1 to generate a reference image TS1. This geometric conversion is performed according to the following formula (D-1) corresponding to formula (B-3) described above. Pixels located at coordinate values (xₐᵤ, yₐᵤ) on the bird's eye view image TI1 are converted by the geometric conversion to pixels located at coordinate values (Xₐᵤ′, yₐᵤ′), and the pixels resulting from the conversion form the reference image TS1. The reference image TS1 corresponds to an image resulting from rotating the bird's eye view image TI1 by the rotation angle θ and also parallelly moving it by the parallel movement amount (Tₓ, T_{y}) on the bird's eye view coordinate plane (in practice, the approximate value of θ≈0 is used).

$$\begin{matrix}[ Formula 11 ] & \\ ( \begin{matrix}{x}_{au}^{′} \\ {y}_{au}^{′}\end{matrix} ) = ( \begin{matrix}1 & - θ \\ θ & 1\end{matrix} ) ( \begin{matrix}{x}_{au} \\ {y}_{au}\end{matrix} ) + ( \begin{matrix}{T}_{x} \\ {T}_{y}\end{matrix} ) & ( D \text{-} 1 )\end{matrix}$$

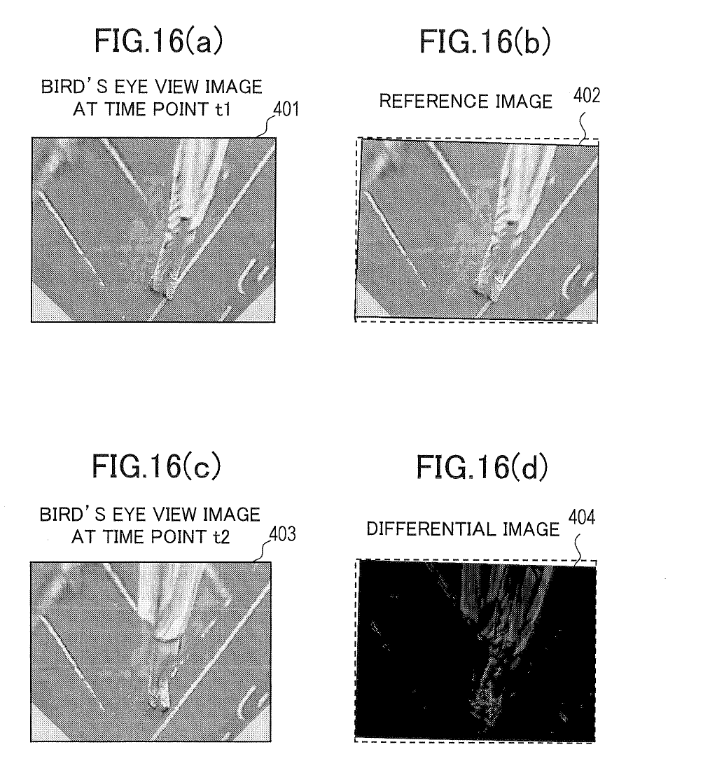

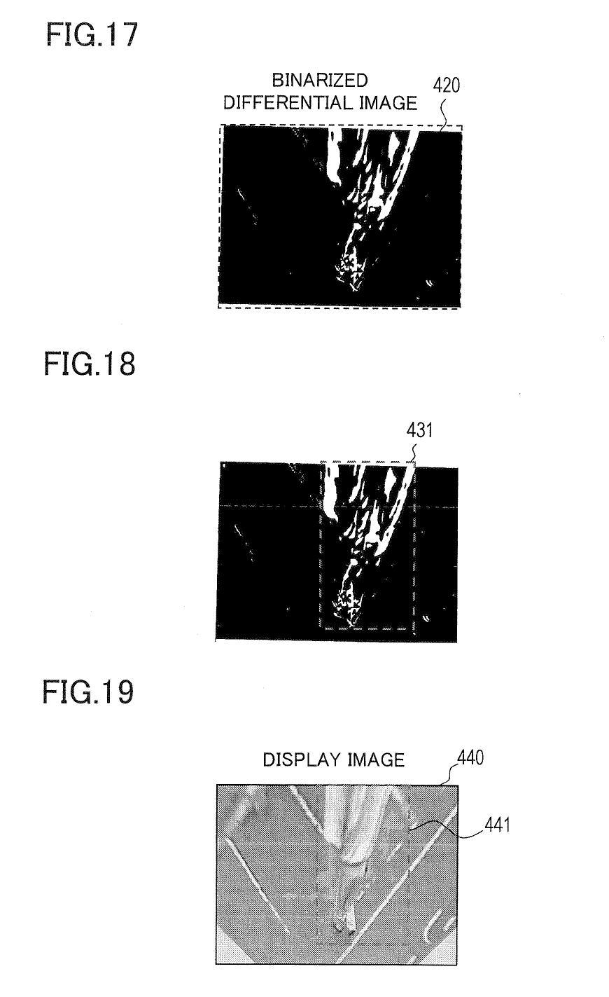

Images 401, 402, 403, and 404 of FIGS. 16(a), (b), (c), and (d), respectively, are examples of the bird's eye view image TI1, the reference image TS1, the bird's eye view image TI2, and the differential image DI, respectively. Close to a middle portion of each of the images 401 to 403, a person appears standing upright on the road surface. Broken-line frames in FIGS. 16(b) and (d) correspond to the outer circumferential frame of the image 401 (the same applies to FIG. 17 which will be described later).

For example, the differential image DI can be generated by using a commonly used frame subtraction. That is, a difference value between pixel values of each pair of pixels located at the same coordinate values on the reference image TS1 and the bird's eye view image TI2 is obtained, and an image having the difference values as the pixel values of the pixels thereon is the difference image DI. In FIG. 16(d), a pixel of a small difference value is shown black, while a pixel of a large difference value is shown white.

In step S18, furthermore, each pixel value of the differential image DI is binarized to generate a binarized differential image. Specifically, the pixel value (that is, the above-described difference value) of each pixel of the differential image DI is compared with a predetermined threshold value, and a pixel value of 1 is given to a pixel whose pixel value is larger than the threshold value (hereinafter, such a pixel will be referred to as distinctive pixel), while a pixel value of 0 is given to a pixel whose pixel value is not larger than the threshold value (hereinafter, such a pixel will be referred to as non-distinctive pixel). The image 420 of FIG. 17 shows an example of the binarized differential image. In FIG. 17, distinctive pixels are shown white, and non-distinctive pixels are shown black. Thereafter, areas within the binarized differential image are classified into an area including many distinctive pixels and an area including many non-distinctive pixels, and an area (for example, a rectangular area) surrounding the former is extracted as a three-dimensional object area. Here, an area formed by a group of a tiny number of distinctive pixels may be judged to come from local noise and left out of the three-dimensional object area. The three-dimensional object area extracted from the binarized differential image 420 is shown in FIG. 18. The area surrounded by a broken line denoted by 431 is the extracted three-dimensional object area.

The position and size of the thus extracted three-dimensional object area are treated as the position and size of the three-dimensional object area on the bird's eye view image TI2. The area out of the three-dimensional object area is estimated as a ground area in which an object without height, such as the road surface, appears. Then, for example, as shown in FIG. 19, a display image is generated in which an indicator that makes the estimated three-dimensional object area visually recognizable as distinct from the other area is superimposed on the bird's eye view age T12, and the display image is displayed on the display device 3. In FIG. 19, an image 440 is the bird's eye view image TI2, and an area within a broken-line rectangular frame 441 displayed superimposed on the image 440 corresponds to the three-dimensional object area.

It is also possible to estimate the position and size of the three-dimensional object area on the bird's eye view image TI1, the camera image I1, or the camera image I2 based on the position and size of the three-dimensional object area on the bird's eye view image TI2. Application, to the three-dimensional object area on the bird's eye view image TI2, of the inverse conversion of the geometric conversion used to obtain the reference image TS1 from the bird's eye view image TI1, determines the position and size of the three-dimensional object area on the bird's eye view age TI1. Application, to the three-dimensional object areas on the bird's eye view images TI1 and TI2, of the inverse conversion of the geometric conversion (the bird's eye conversion described above) used to obtain the bird's eye view images TI1 and T12 from the camera images I1 and 12, determines the positions and sizes of the three-dimensional object areas on the camera images I1 and I2.

According to the above-discussed example, a ground feature point is accurately extracted by simple operational processing, and this makes it possible to accurately estimate vehicle movement information and a three-dimensional object area with a low operational load. Accurate identification of a three-dimensional object area leads to desirable operation support.

### Example 2

Example 2 will be described next. In Example 1, the differential image DI is generated by obtaining the difference in pixel value between the reference image TS1 and the bird's eye view image TI2 with respect to each pixel. This method, however, is prone to be negatively affected by local noise. In Example 2, a differential image generating method and a three-dimensional object area estimation method less prone to be negatively affected by local noise will be discussed. Example 2 corresponds to an example resulting from partially modifying Example 1, and, unless inconsistent, any feature in Example 1 is applicable to Example 2. The operation performed until the bird's eye view images TI1 and TI2 and the reference image TS1 are obtained via the processing in steps S11 to S17 and part of the processing in step S18 in FIG. 5 is performed in the same manner as in Example 1, and thus the description will be focused on what is done after the operation.

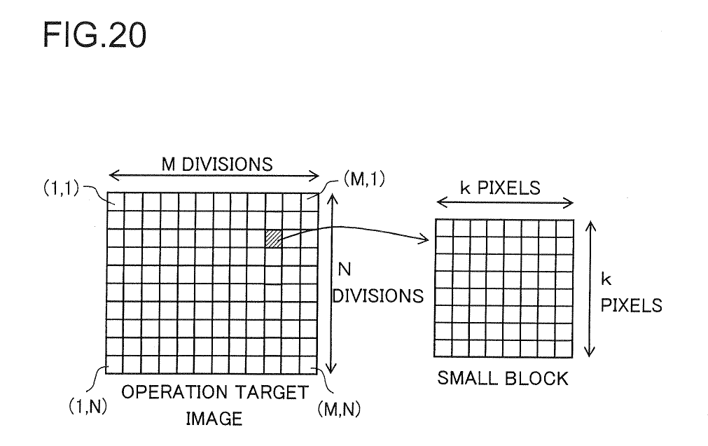

In Example 2, the bird's eye view image TI2 and the reference image TS1 are each treated as an operation target image (image with respect to which an operation is performed). And, as shown in FIG. 20, the entire area of an operation target image are divided into a plurality of sections both in horizontal and vertical directions to thereby set a plurality of small blocks in the operation target image. Now, assume that the operation target image is divided into M sections in the horizontal direction and N sections in the vertical direction (M and N are integers of 2 or more). Each small block is formed of (k×k) pixels (k is an integer of 2 or more, for example, 8). Also, m and n are introduced as signs for indicating the horizontal and vertical positions, respectively, of a small block within the operation target image (m is an integer value satisfying 1≦m≦M, and n is an integer value satisfying 1≦n≦N). A larger m indicates a horizontal position closer to the right, and a larger n indicates a vertical position closer to the bottom. A block position of a small block is represented by (m, n) as a combination of the horizontal position m and the vertical position n.

A small block at a block position (m, n) in the bird's eye view image TI2 and a small block at a block position (m, n) in the reference image TS1 are made to correspond to each other. When the bird's eye view image TI1 and the reference image TS1 are superimposed on the same bird's eye view coordinate plane, some areas at their edges do not overlap with each other (see FIGS. 16(b) and 16(c)) due to the rotation and parallel movement in generating the reference image TS1 from the bird's eye view image T11. Here, however, no attention is paid to the presence of such areas. More precisely, for example, an image within a rectangular area included in the overlapping portion of the two images may be treated as the operation target image.

After setting the small blocks in the above-described manner, a differential image is generated in the following manner. As examples of the method of generating the differential image, first to three generation methods will now be described one by one.

[First Generation Method]

A first generation method will be described. In the first generation method, a color space histogram is obtained for each small block. And, the color space histograms are compared between the bird's eye view mage TI2 and the reference image TS1 to thereby calculate a difference degree ε₁. For example, first to Qth divisions are provided in an RGB color space by dividing the RGB color space into Q pieces, and which division each pixel is to belong to is determined by mapping each pixel onto the RGB color space based on its color information (Q is an integer of 2 or more). The color space histograms may be obtained based on a color space other than the RGB color space (for example, an HSV color space). The difference degree ε₁ is calculated for each block position, but here, the calculation method will be described with respect to a target block position on which attention is focused.

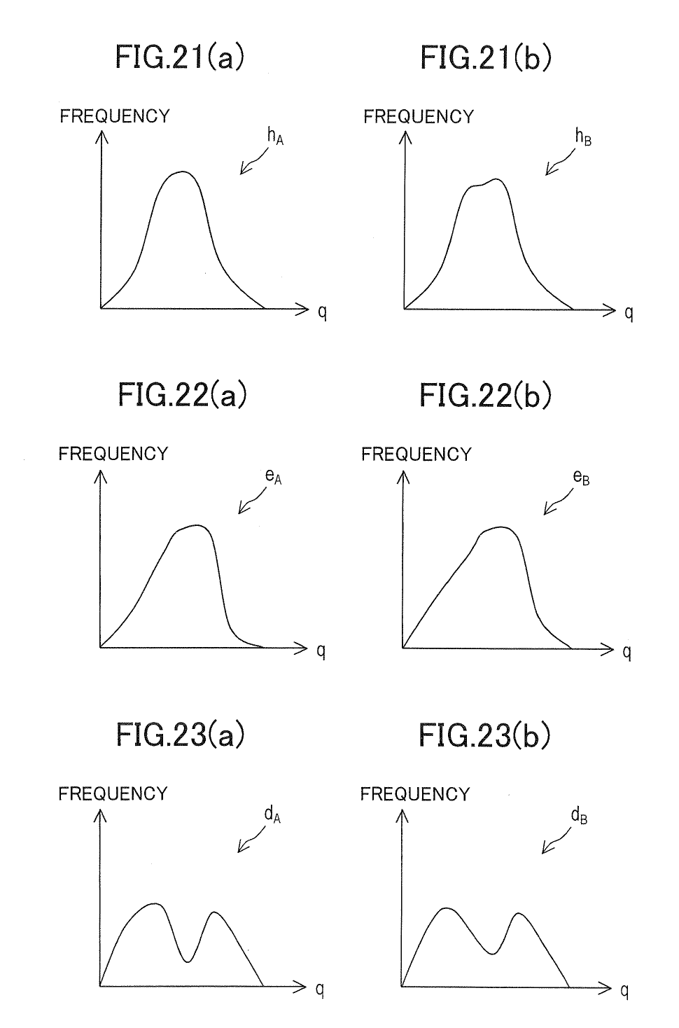

FIG. 21(a) shows a color space histogram h_{A} of a small block at the target block position in the bird's eye view image TI2. FIG. 21 (b) shows a color space histogram h_{B} of a small block at the target block position in the reference image TS1. Among the pixels forming the small block in the former, the number of pixels whose color information belongs to a qth division is denoted by h_{A}(q), and among the pixels forming the small block in the latter, the number of pixels whose color information belongs to the qth division is denoted by h_{B}(q) (1≦q≦Q). Then, the difference degree ε₁ is calculated according to the following formula (E-1).

$$\begin{matrix}[ Formula 12 ] & \\ {ɛ}_{1} = {\sum }_{q = 1}^{Q} {\{ {h}_{A} ( q ) - {h}_{B} ( q ) \}}^{2} & ( E \text{-} 1 )\end{matrix}$$

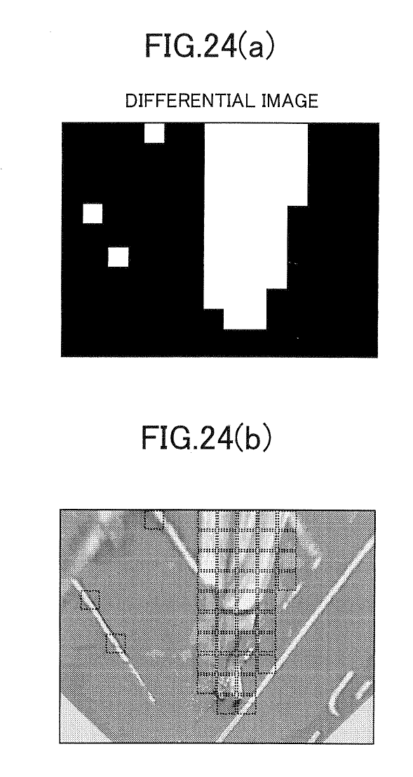

Such a difference degree ε₁ is obtained with respect to each block position, block positions where the difference degree ε₁ are larger than a predetermine positive threshold value are identified, and small blocks at the identified block positions in the bird's eye view image TI2 are set as component blocks. Small blocks in the bird's eye view image TI2 other than the component blocks are called non-component blocks. And by giving each pixel in the component blocks a pixel value of 1 and giving each pixel in the non-component blocks a pixel value of 0, a differential image as a binarized image is obtained. An example of the thus obtained differential image is shown in FIG. 24(a). In the differential image shown in FIG. 24(a), the component blocks are shown white while the non-component blocks are shown black.

[Second Generation Method]

A second generation method will be described. In the second generation method, an edge intensity histogram is obtained for each small block. And, the edge intensity histograms are compared between the bird's eye view image TI2 and the reference image TS1 to thereby calculate a difference degree ε₂.

Specifically, by applying edge extraction processing to each pixel in the bird's eye view image TI2 and the reference image TS1 by use of any edge extraction filter such as a Laplacian filter, a first edge extraction image based on the bird's eye view image TI2 and a second edge extraction image based on the reference image TS1 are generated. As is publicly known, pixel values of pixels forming an edge extraction image indicate edge intensity. First to Qth divisions are provided which are different from each other in edge intensity, and the pixels in the edge extraction images are each classified into one of the first to Qth divisions (Q is an integer of 2 or more) according to their pixel values (that is, edge intensity).

The difference degree ε₂ is calculated for each block position, but here, the calculation method will be described with respect to a target block position on which attention is focused. FIG. 22(a) shows an edge intensity histogram e_{A} of a small block at the target block position in the first edge extraction image, and FIG. 22(b) shows an edge intensity histogram e_{B} of a small block at the target block position in the second edge extraction image. Among the pixels forming the small block in the former, the number of pixels whose edge intensities belong to a qth division is denoted by e_{A}(q), and among the pixels forming the small block in the latter, the number of pixels whose edge intensities belong to the qth division is denoted by e_{B}(q) (1≦q≦Q). Then, the difference degree ε₂ is calculated according to the following formula (E-2).

$$\begin{matrix}[ Formula 13 ] & \\ {ɛ}_{2} = {\sum }_{q = 1}^{Q} {\{ {e}_{A} ( q ) - {e}_{B} ( q ) \}}^{2} & ( E \text{-} 2 )\end{matrix}$$

Such a difference degree ε₂ is obtained for each block position, block positions where the difference degree ε₂ is larger than a predetermine positive threshold value are identified, and small blocks at the identified block positions in the bird's eye view image T12 are set as component blocks. Small blocks in the bird's eye view image 112 other than the component blocks are called non-component blocks. And by giving each pixel in the component blocks a pixel value of 1 and giving each pixel in the non-component blocks a pixel value of 0, a differential image as a binarized image is obtained.

[Third Generation Method]

A third generation method will be described. In the third generation method, edge direction histograms are obtained one for each small block. And, the edge direction histograms are compared between the bird's eye view image TI2 and the reference image TS1 to thereby calculate a difference degree ε₃.

Specifically, by applying edge extraction processing to each pixel in the bird's eye view image T12 and the reference image TS1 by use of any edge extraction filter such as a Laplacian filter, a large number of edges are extracted from the bird's eye view image 112 and the reference image TS1, and edge directions of the extracted edges are detected. An edge means where brightness sharply changes in an image, and an edge direction means a direction of the sharp change in brightness. First to Qth divisions are provided which are different from each other in edge direction, and the extracted edges are each classified into one of the first to Qth divisions (Q is an integer of 2 or more) according to their edge directions.

The difference degree ε₃ is calculated for each block position, but here, the calculation method will be described with respect to a target block position on which attention is focused. FIG. 23(a) shows an edge direction histogram d_{A} of a small block at the target block position in the bird's eye view image T12, and FIG. 23(b) shows an edge direction histogram d_{B} of a small block at the target block position in the reference image TS1. Among the plurality of edges extracted from the small block in the former, the number of edges whose edge directions belong to the qth division is denoted by d_{A}(q), and among the plurality of edges extracted from the small block in the latter, the number of edges whose edge directions belong to the qth division is denoted by d_{B}(q) (1≦q≦Q). Then, the difference degree ε₃ is calculated according to the following formula (E-3).

$$\begin{matrix}[ Formula 14 ] & \\ {ɛ}_{3} = {\sum }_{q = 1}^{Q} {\{ {d}_{A} ( q ) - {d}_{B} ( q ) \}}^{2} & ( E \text{-} 3 )\end{matrix}$$

Such a difference degree ε₃ is obtained for each block position, block positions where the difference degree ε₃ is larger than a predetermine positive threshold value are identified, and small blocks at the identified block positions in the bird's eye view image T12 are set as component blocks. Small blocks in the bird's eye view image T12 other than the component blocks are called non-component blocks. And by giving each pixel in the component blocks a pixel value of 1 and giving each pixel in the non-component blocks a pixel value of 0, a differential image as a binarized image is obtained.

[Estimation of Three-Dimensional Object Area]

FIG. 24(b) shows the image 403 shown in FIG. 16(c) as an image example of the bird's eye view image TI2 with component blocks which are set by use of any one of the above-described first to third generation methods superimposed thereon. In FIG. 24(b), blocks within a broken-line frame are component blocks. For simplification, it is possible to estimate, as a three-dimensional object area on the bird's eye view image TI2, a synthetic area resulting from synthesizing all the set component blocks or an area (for example, a rectangular area) surrounding the synthetic area.

However, it is desirable that a three-dimensional object area is finally identified by executing, with each component block regarded as a candidate for a component of a three-dimensional object area, area combining processing for forming a combination area by combining a group of neighboring component blocks and elimination processing for eliminating a component block spacially isolated from other component blocks and a small-sized combination area. For example, it is judged whether or not a component block and another component block (or a combination area) are adjacent to each other, and if they are found to be adjacent to each other, they are combined together to form a new combination area. This processing is repeatedly executed until new combination is not performed any more. Then, sizes of the thus obtained combination areas are checked, and a combination area of a predetermined size or smaller and an uncombined component block are eliminated. A finally remaining combination area or an area (for example, a rectangular area) surrounding the combination area is estimated as a three-dimensional object area on the bird's eye view image TI2. As a result, a three-dimensional object area as indicated by a broken line frame 431 in FIG. 18 is estimated. The operation performed after the three-dimensional object area on the bird's eye view age TI2 is estimated is as already described in the description of Example 1.

### Example 3

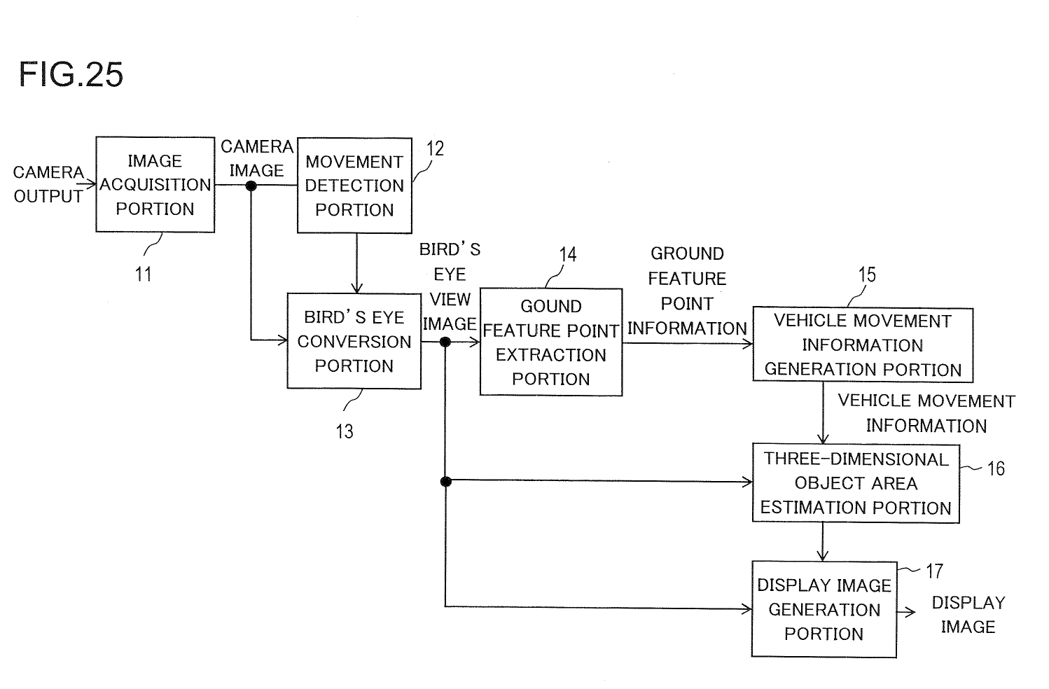

Next, example 3 will be described. In Example 3, a description will be given of an example of a functional block diagram of an operation support system corresponding to the practical examples described above. FIG. 25 is a functional block diagram of an operation support system according to Example 3. The operation support system according to Example 3 includes blocks referred to by the reference signs 11 to 17, and these blocks referred to by the reference signs 11 to 17 are provided in the image processing device 2 in FIG. 1.

An image acquisition portion 11 acquires one camera image after another based on an output signal of the camera 1. The image data of each camera image is fed from the image acquisition portion 11 to a movement detection portion (movement vector detection portion) 12 and to a bird's eye conversion portion 13. The movement detection portion 12 executes processing of step S12 and processing of step S13 shown in FIG. 5. That is, the movement detection portion 12 extracts a feature point and calculates a movement vector of the extracted feature point. The bird's eye conversion portion 13 executes processing of step S14 and processing of step S15 shown in FIG. 5. That is, the bird's eye conversion portion 13 converts each camera image into a bird's eye view image and maps feature points and movement vectors on each camera coordinate plane onto the bird's eye view coordinate plane. A ground feature point extraction portion (determination portion) 14 executes processing of step S16 in FIG. 5 to extract ground feature points, and a vehicle movement information generation portion (movement information estimation portion) 15 executes processing of step S17 in FIG. 5 to generate vehicle movement information from ground feature point information with respect to the extracted ground feature points. A three-dimensional object area estimation portion 16 executes processing of step S18 in FIG. 5. That is, the three-dimensional object area estimation portion 16 estimates the above three-dimensional object area based on the bird's eye view images at time points t1 and t2 and the vehicle movement information. A display image generation portion 17 processes the bird's eye view image according to the estimation result of the three-dimensional object area so as to make the three-dimensional object area visually recognizable, to thereby generate a display image. Instead, an image obtained by processing a camera image so as to make the three-dimensional object area visually recognizable may be generated as a display image.

<<Modifications and Variations>>

The specific values given in the descriptions above are merely examples, which, needless to say, may be modified to any other values. In connection with the examples described above, modified examples or supplementary explanations applicable to them will be given below in Notes 1 to 5. Unless inconsistent, any part of the contents of these notes may be combined with any other.

[Note 1]

Although a method for obtaining a bird's eye view image from a camera image by perspective projection conversion is described, it is also possible to obtain a bird's eye view image from a camera image, instead, by planar projection conversion. In this case, a homography matrix (planar projection matrix) for converting the coordinates of the individual pixels on a camera image into the coordinates of the individual pixels on a bird's eye view image is determined by camera calibration performed prior to actual use. The homography matrix is determined by a known method. Then, in a case in which the operation shown in FIG. 5 is performed, a camera image may be converted into a bird's eye view image based on the homography matrix. In this case, mapping of a feature point and a movement vector onto a bird's eye view image coordinate plane in step S15 of FIG. 5 can also be performed based on the homography matrix.

[Note 2]

Although the above examples deal with cases where the camera 1 is installed in a rear part of the vehicle 100 so as to have a field of view rearward of the vehicle 100, it is also possible to install the camera 1, instead, in a front or side part of the vehicle 100 so as to have a field of view frontward or sideward of the vehicle 100. Even with the camera 1 so installed, it is possible to perform processing similar to that described above, including processing for estimating a three-dimensional object area.

[Note 3]

In the embodiments described above, a display image based on a camera image obtained from a single camera is displayed on the display device 3. Instead, it is also possible to install a plurality of cameras (not shown) on the vehicle 100 and generate a display image based on a plurality of camera images obtained from the plurality of cameras. For example, it is possible to fit one or more additional cameras to the vehicle 100 in addition to the camera 1. In this case, it is possible to merge images based on camera images obtained from the additional cameras with an image (for example, the image 440 shown in FIG. 19) based on the camera image obtained from the camera 1 and finally use the thereby obtained merged image as a display image to be displayed on the display device 3. The merged image resulting from this merging is, for example, an all-around bird's eye view image as disclosed in JP-A-2006

[Note 4]

In the embodiments described above, an automobile is dealt with as an example of a vehicle. It is, however, also possible to apply the present invention to vehicles that are not classified into automobiles, and even to mobile objects that are not classified into vehicles. For example, a mobile object that is not classified into vehicles has no wheel and moves by use of a mechanism other than a wheel. For example, it is possible to apply the present invention to, as a mobile object, a robot (unillustrated) that moves around inside a factory by remote control.

[Note 5]

The functions of the image processing device 2 shown in FIG. 1 and of the blocks shown in FIG. 25 are realized in hardware, in software, or in a combination of hardware and software. All or part of the functions of the image processing device 2 shown in FIG. 1 and of the blocks shown in FIG. 25 may be prepared in the form of a software program so that, when this software program is executed on a computer, all or part of those functions are realized.

1. An operation support system which is provided with a camera fitted to a mobile object to shoot surroundings of the mobile object, and which estimates, based on camera images on a camera coordinate plane obtained from the camera, a three-dimensional object area in an image based on the camera image, the operation support system comprising:
an image acquisition portion which acquires first and second camera images shot by the camera at first and second time points, respectively, while the mobile object is moving, the first and second time points being different from each other;
a movement vector detection portion which extracts n feature points (where n is an integer of 2 or more) from the first camera image, and which also detects movement vectors, on the camera coordinate plane, of the feature points between the first and second camera images;
a bird's eye conversion portion which projects the camera images, and the feature points and the movement vectors on the camera coordinate plane onto a bird's eye view coordinate plane which is parallel to ground to thereby convert the first and second camera images into first and second bird's eye view images, respectively, and detect positions of the feature points on the first bird's eye view image and movement vectors of the feature points on the bird's eye view coordinate plane between the first and second bird's eye view images;
a determination portion which determines, by use of a restraint condition for a ground feature point located on the ground to satisfy, whether or not a target feature point on the first bird's eye view image is the ground feature point;
a movement information estimation portion which estimates movement information of the mobile object between the first and second time points based on positions on the first bird's eye view image, and movement vectors on the bird's eye view coordinate plane, of two or more feature points which are each judged as the ground feature point; and
a three-dimensional object area estimation portion which estimates the three-dimensional object area based on the first and second bird's eye view images and the movement information.

2. The operation support system of claim 1, wherein the restraint condition defines a relationship which should be satisfied by a rotation angle and a parallel movement amount of the mobile object between the first and second time points and a position on the first bird's eye view image, and a movement vector on the bird's eye view coordinate plane, of the ground feature point.

3. The operation support system of claim 2, wherein the determination portion extracts, as target feature points, two or more feature points from among the n feature points on the first bird's eye view image, and determines whether or not the target feature points are each the ground feature point by determining whether or not the target feature points satisfy the restraint condition.

4. The operation support system of claim 2, wherein the determination portion
extracts, as target feature points, two or more feature points from among the n feature points on the first bird's eye view image,
obtains two or more estimation values of the rotation angle and two or more estimation values of the parallel movement amount by applying the two or more target feature points to the relationship, on an assumption that the two or more target feature points are each the ground feature point, and
determines whether or not the target feature points are each the ground feature point, based on a variation among the estimation values of the rotation angle and a variation among the estimation values of the parallel movement amount.

5. The operation support system of claim 2, wherein the movement information includes information which indicates the rotation angle and the parallel movement amount of the mobile object.

6. The operation support system of claim 1, wherein
the three-dimensional object area estimation portion
corrects, based on the movement information, displacement between the first and second bird's eye view images attributable to the mobile object moving between the first and second time points, and
estimates the three-dimensional object area based on a comparison result between the first and second bird's eye view images after the displacement is corrected.

7. The operation support system of claim 1, wherein the three-dimensional object area which is estimated corresponds to an area where a three-dimensional object appears in the first camera image, in the second camera image, in the first bird's eye view image, or in the second bird's eye view image.

8. A vehicle as a mobile object, comprising the operation support system of claim 1.

9. A three-dimensional object area estimation method for estimating, based on a camera image on a camera coordinate plane obtained from a camera fitted to a mobile object to shoot surroundings of the mobile object, a three-dimensional object area in an image based on the camera image, the three-dimensional object area estimation method comprising:
an image acquisition step for acquiring first and second camera images shot by the camera at first and second time points, respectively, while the mobile object is moving, the first and second time points being different from each other;
a movement vector detection step for extracting n feature points (where n is an integer of 2 or more) from the first camera image, and detecting movement vectors of the feature points on the camera coordinate plane between the first and second camera images;
a bird's eye conversion step for projecting the camera images, and the feature points and the movement vectors on the camera coordinate plane onto a bird's eye view coordinate plane which is parallel to ground, to thereby convert the first and second camera images into first and second bird's eye view images, respectively, and detect positions of the feature points on the first bird's eye view image and movement vectors of the feature points on the bird's eye view coordinate plane between the first and second bird's eye view images;
a determination step for determining, by use of a restraint condition for a ground feature point located on the ground to satisfy, whether or not a target feature point on the first bird's eye view image is the ground feature point;
a movement information estimation step for estimating movement information of the mobile object between the first and second time points based on positions on the first bird's eye view image, and movement vectors on the bird's eye view coordinate plane, of two or more feature points which are each judged as the ground feature point; and
a three-dimensional object area estimation step for estimating the three-dimensional object area based on the first and second bird's eye view images and the movement information.

10. The operation support system of claim 3, wherein the movement information includes information which indicates the rotation angle and the parallel movement amount of the mobile object.

11. The operation support system of claim 4, wherein the movement information includes information which indicates the rotation angle and the parallel movement amount of the mobile object.

12. The operation support system of claim 2, wherein
the three-dimensional object area estimation portion
corrects, based on the movement information, displacement between the first and second bird's eye view images attributable to the mobile object moving between the first and second time points, and
estimates the three-dimensional object area based on a comparison result between the first and second bird's eye view images after the displacement is corrected.

13. The operation support system of claim 3, wherein
the three-dimensional object area estimation portion
corrects, based on the movement information, displacement between the first and second bird's eye view images attributable to the mobile object moving between the first and second time points, and
estimates the three-dimensional object area based on a comparison result between the first and second bird's eye view images after the displacement is corrected.

14. The operation support system of claim 4, wherein
the three-dimensional object area estimation portion
corrects, based on the movement information, displacement between the first and second bird's eye view images attributable to the mobile object moving between the first and second time points, and
estimates the three-dimensional object area based on a comparison result between the first and second bird's eye view images after the displacement is corrected.

15. The operation support system of claim 2, wherein the three-dimensional object area which is estimated corresponds to an area where a three-dimensional object appears in the first camera image, in the second camera image, in the first bird's eye view image, or in the second bird's eye view image.

16. The operation support system of claim 3, wherein the three-dimensional object area which is estimated corresponds to an area where a three-dimensional object appears in the first camera image, in the second camera image, in the first bird's eye view image, or in the second bird's eye view image.

17. The operation support system of claim 4, wherein the three-dimensional object area which is estimated corresponds to an area where a three-dimensional object appears in the first camera image, in the second camera image, in the first bird's eye view image, or in the second bird's eye view image.

18. A vehicle as a mobile object, comprising the operation support system of claim 2.

19. A vehicle as a mobile object, comprising the operation support system of claim 3.

20. A vehicle as a mobile object, comprising the operation support system of claim 4.
